(19) United States
(12) Patent Application Publication
(10) Pub. No.: US 2012/0095891 A1
(43) Pub. Date: Apr. 19, 2012

(54) SYSTEMS AND METHODS FOR PROBATE CLAIM IDENTIFICATION AND MERGING

(75) Inventors: Angela Marie Horn, Minneapolis, MN (US); Dereck John Eastman, Minneapolis, MN (US)

(73) Assignee: FORTE LLC, Minneapolis, MN (US)

(21) Appl. No.: 12/906,556

(22) Filed: Oct. 18, 2010

(51) Int. Cl. G06Q 40/00

(52) U.S. Cl. 705/35

(57) ABSTRACT

Various embodiments include at least one of systems, methods, and software for probate claim identification and merging. One such embodiment includes processing, utilizing a computer processor, debtor account records stored in an account database to match debtor account records with probate estate records stored in a probate estate database. Upon identification of a match of a debtor account record with a probate estate record, the debtor account record may be associated with the probate estate record. Subsequently a claims process may be executed to generate claims against probate estates. Generating such a claim, when two or more accounts are identified for a single debtor, may consist of generating a single claim against the probate estate of the debtor. The single claim is for each of a plurality of accounts of the debtor of a particular client.

### BACKGROUND INFORMATION

An increasing number of creditors operate on a national scale. Debtor customers of a national creditor can live virtually anywhere throughout the country, and even the world. Thus, discovering that a debtor has passed on becomes difficult. Further, when a debtor passes on, locating a probate estate of the debtor against which to submit a claim to satisfy the debtor's outstanding balance is even more difficult. Also, it is quite common for a deceased debtor to have multiple accounts with a single creditor. In such instances, when a probate estate is located for the deceased debtor, generating and filing probate claims for each of the multiple credit accounts poses processing redundancy issues, considerable time and financial expenses, and presentation of a large number of documents on the court in which the probate estate exists.

### BRIEF DESCRIPTION OF THE DRAWINGS

FIG. 1 is a flow diagram of a method according to an example embodiment.

FIG. 2 is a flow diagram of a method according to an example embodiment.

FIG. 3 is a block diagram of a system according to an embodiment.

FIG. 4 is a block diagram of a computing device according to an example embodiment.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

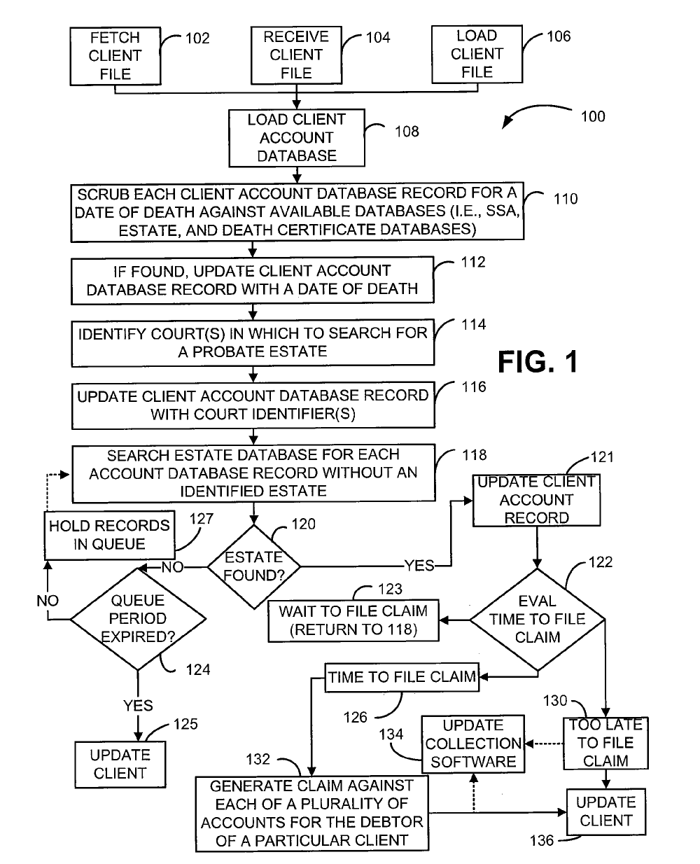

FIG. 1 is a flow diagram of a method 100 according to an example embodiment. At a high-level, this method 100 operates to verify or determine that a client debtor is deceased, to locate a probate estate of the client debtor, and to facilitate the filing of a claim against the client debtor probate estate. As part of this process, the method 100, in some embodiments, operates to identify all accounts of a deceased client debtor and filing a single claim against the client debtor probate estate. In the event that accounts are identified for the deceased client debtor from multiple clients, claims may be filed against the probate estate for each of the multiple clients. However, in some other embodiments, ownership of the accounts of the deceased client debtor may be transferred from the multiple clients to a single entity, such as a collection agency or other agent of the multiple clients performing the method 100. In other embodiments, depending on the requirements as to who may make a probate claim in a court where a probate estate exists, a right to make the claim may be assigned to the agent. The single entity may then file a single probate claim for all of the multiple accounts. Some embodiments may also determine if time is remaining to file a claim. When time is remaining, depending on how much time is remaining the method 100 may include waiting an additional period before filing a probate claim to allow additional time for additional accounts of the deceased client debtor to be identified. These and other embodiments are described in further detail below.

The method 100 processes client data. The client in this context is a source of data. The client can include an entity that owns debt, services debt accounts owned by another entity, lends money, or a client of a data processing entity performing the method 100 on the client's data. The client may also be a probate estate creditor or probate estate claimant. The data is obtained from the client in any number of ways. For example, the data may be obtained from the client by fetching a client file 102 from a client over a network (e.g., the client file is pulled), receiving a client file 104 over a network from the client (e.g., the client file is pushed), or loading a client file 106 from a tape, disk, or other computer readable medium (e.g., a file that is sent via standard mail, freight, or other shipping means). Some embodiments include obtaining the data as a flat file having defined record lengths, field delimiters, or other similar type file. Other embodiments include receiving the file encoded in a markup language such as eXtensible Markup Language (“XML”). Yet further embodiments include a data exchange arrangement utilizing a technology such as Electronic Data Interchange (“EDI”). Other methods, means, and mechanisms to obtain the client data can also be used.

After the data is obtained, the data is loaded into a client account database 108. The client account database 108 includes various items of data for each client account identified in the obtained data. In some embodiments, this data includes name, address, phone number, spouse data, next of kin contact information, outstanding balance amounts, a date of death (if known), and other personal and demographic information, based on the client and the particular embodiment.

Once the data is loaded into the client account database 108, each client account database record is processed for a date of death against one or more available databases 110. Such databases can include a database including data from the “Death Master File” maintained by the United States Social Security Administration (“SSA”) and available from the United States Department of Commerce's National Technical Information Service (“NTIS”), an estate database including a record for many probate estates previously identified to be in certain courts, a death certificate database including data from death certificates, or other commercial, public, or proprietary data stored in a database including data about deceased individuals. In the event that a date of death is received from a client, that date of death is verified against the available databases. If a date of death is not identified by the processing 110, the method still proceeds. If a date of death is identified or verified, the respective client account database record is updated with the date of death 112.

The method 100 further includes identifying one or more courts in which to search for a probate estate 114 of each client account database record. In some embodiments, a court in which to search for a probate estate is identified at 114 based on address information in a client account database record. For example, one embodiment includes a court table in a database. The court table includes the columns city, state, zip, and court. The columns city, state, and zip form a unique key. Thus, when submitting a database query to select a court using the city, state, and zip code of an address as the key, the query will return a single court. In some embodiments, a city and state combination is sufficient. In yet other embodiments, a zip code or a zip+4 is sufficient. Example structured query language (“SQL”) select statements are as follows:

SELECT court FROM court_table
WHERE

| city = x, | | city = x, | zip = z; |
|---|---|---|---|
| state = y, | OR | state = y; OR | |

zip = z;

In the event a client account database record has more than one address, more than one court can be identified, one court for each unique city, state, zip combination, and subsequently searched for the probate estate.

Once one or more courts in which to search for a probate estate are identified 114, the respective client account database record may be updated with one or more court identifiers 116. The court identifier can be a name and address of the court. In other embodiments, the identifier is a relational key into another table including the court information.

For each identified court at 114 of a client account database record without a previously identified court, the method 100 searches an estate database to locate the estate at 118. The estate database, in some embodiments, includes records of identified probate estates. The estate database, in some embodiments, is a proprietary database of an entity performing the method 100. In some embodiments, the estate database includes publicly available data from courts, newspapers, public notices, and from previous probate estate searches. Data from courts can be received directly from courts in an electronic form and as entered data resulting from manual searches performed at the courts. Newspaper and public notices are generally provided to the estate database via manual data entry, but in some circumstances, such data can be received in electronic form from one or more sources including the newspapers themselves. Results from previous probate estate searches are generally manually entered into the database as a result of data obtained by an electronic or mailed letter request for probate estate information from a court.

Following the search of the estate database 118, the method 100 determines if an estate has been found at 120. If an estate is found at 120 the client account record is updated 121.

If, however, the search 118 of the estate database fails to locate an estate, the method 100 determines whether a queue period has expired 124. If not, the client account record is placed in a hold records queue 127. Client account records are placed in the hold records queue 127 in the event that a probate estate is not identified for the client account record. The estate database is searched 118 for the client account records in the queue 127 on a recurring, periodic basis while the client account records remain in the queue 127. The periodic, recurring basis at which the client account records in the queue are searched 118 varies by the particular embodiment. Some embodiments include performing the queue 127 search 118 on a weekly or daily basis. In other embodiments, the period may vary based on a schedule of a particular embodiment. The client account records remain in the queue, in some embodiments, for up to 52 weeks, unless a probate estate is identified in a particular court before the end of the 52 weeks. Other embodiments include maintaining the queued client account records for shorter and longer periods. For example, a client account record in some embodiments may remain in the queue for five years, seven years, or even indefinitely. In such embodiments, the client account record is monitored to ensure timely notice upon a probate estate being created in a court that is relevant to the client account record. When the queue period has expired at 124, the method 100 includes updating the client account record at 125 regarding the expiration and the method with regard to the updated client account record is complete.

Returning to the determination if an estate has been found at 120, if a probate estate is found, the method 100 is also capable of determining 122 if there is time remaining to file a claim against the probate estate. In some jurisdictions, claims against the estate of a decedent must be filed within a certain period, such as six or twelve months of a date, which may be a date of death, a date a probate estate comes before a court, or other date. These periods within which claims must be filed against an estate are normally established by jurisdictional statute, such as in a state probate code, although they may be set or modified by local court rules. The period within which a claim must be made may be referred to as a “presentment period,” and outside of the period may be referred to as a “non-claims period.” The determination 122 of whether or not there is time remaining to file a claim may take into account a current date, a date in a probate estate record in the estate database, and a court rule. The court rule may be represented in computer code of a program performing the method or retrievable from a database record for the court within which the probate estate exists.

Depending on the determination 122, different actions may be taken in the method 100. For example, if it is too late to file a claim 130, the method 100 may simply update 136 the client account record being processed and not generate and file a claim. However, if there is time remaining to file a claim against the estate, depending on the amount of time remaining, the method 100 may include waiting 123 an additional period to generate and file a claim to allow more time for additional claims to be identified, such as by returning to the searching at block 118 of the method 100. The additional period to wait 123 is typically based on a configuration setting. That configuration setting may set a specific period to wait (number of days, number of weeks, etc.), a relative time to an event such as a date when claims must be filed by or from identification of the probate estate, or other setting depending on specific embodiment.

When the determination 122 is that it is time to file a claim 126, the method 100 includes generating 132 a claim against each of a plurality of accounts represented by multiple client account records. The multiple client account records are representative of accounts of a single client debtor of a particular client. Thus, a single claim may be generated 132 for multiple accounts of a single deceased debtor. This reduces the number of documents and generated during the probate process. This increases the efficiencies of the organization causing the method 100 to be performed and of the court system in administering probate estates, as there are fewer documents to process, log, and review. A determination 122 that it is time to file a claim 126, may be based on an amount of time remaining to file the claim or that time to file the claim has expired and the client wants to file a claim regardless.

Generating 132 the claim may include automatically merging a claim form and submitting the claim. In some embodiments, a claim form is customized based on requirements of a court to which the claim is submitted. In yet further embodiments, merging the claim form includes generating a data structure required for electronic filing by a court and submitting the claim electronically. However, submitting the claim form may include printing, executing, and mailing the merged claim form to an appropriate location, such as a clerk of court office. Some embodiments include updating a debt collection software package 134 regarding the claim filing to cause any such actions in the collection software or changes in collection activity regarding the client account as desired to occur. The client is updated at 136 regarding the action taken.

Returning to the determination 122 if there is time remaining to file a claim at 128, when a claim has not been filed before the expiration of time, according to court rules it is too late to file a claim. Some embodiments include updating the collection software package at 134 regarding the inability to file a claim against the estate to cause any such actions in the collection software or changes in collection activity regarding the client debtor account as desired to occur. The client is updated 136 regarding the action taken.

At this point, the method 100 has completed processing a client account database record. However, the method 100 continues to execute until all client account database records have been processed according to the method 100. The method 100 further continues to process records in the hold queue 127 on the recurring, periodic basis and client files continue to be loaded to the client account database 108 as they are obtained. Thus, the method 100 is typically an ongoing process.

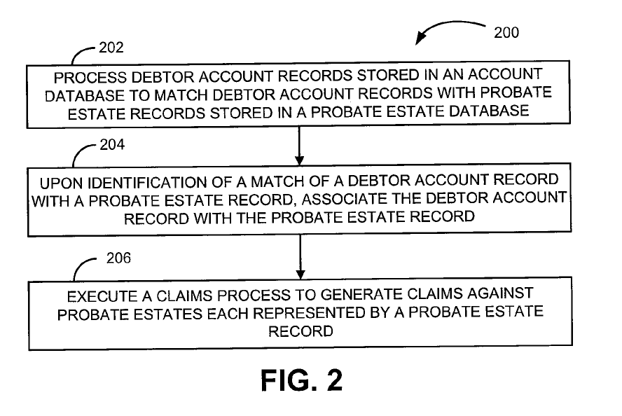

FIG. 2 is a flow diagram of a method 200 according to an example embodiment. The method 200 is an example of a method that may be performed by a data processing system, such as a server computer, to monitor debtor account records against a database of probate estates of deceased individuals. The method may further be performed to initiate and execute a probate estate claims process upon matching one or more debtor account records with a probate estate.

In some embodiments, the method 200 includes processing 202 debtor account records stored in an account database. The processing 202 is performed to match debtor account records with probate estate records stored in a probate estate database. Upon identification of a match of a debtor account record with a probate estate record, the method 200 includes associating 204 the debtor account record with the probate estate record. The associating 204, in some embodiments, is made in a relational database table.

The method 200 may further include executing 206 a claims process to generate claims against probate estates each represented by a probate estate record. In such embodiments, a single claim may be generated against a single probate estate of a debtor for each of a plurality of accounts of the debtor of a particular client. In such embodiments, each account may be represented by a debtor account record and the debtor and the client may be identified in each of the debtor account records.

In some embodiments of the method 200, associating the debtor account record with the probate estate record includes adding data representative of the debtor account record and data representative of the identified probate estate record to a work in progress (WIP) table. In other embodiments, upon identification of a match 204, a claim record may be generated in a claim database table along with a record in a linking table that links debtor account records to claim records. Through the linking table, a single claim may have multiple associated accounts that are readily identifiable when the method 200 causes execution 206 of the claims process. In some other embodiments, associating the debtor account record with the probate estate record includes updating the debtor account record to include an identifier of the probate estate record.

Executing 206 the claims process to generate claims may include generating a dataset for each claim to be filed. Such a generated dataset may include data to populate a court-specific probate estate claim template. Court-specific probate estate claim templates may be stored in a template repository and accessible by a client computing device to present a view of claim datasets and to generate output to use in submitting the claim to a court where the probate estate exists. The generated output to use in submitting the claim may include a printed document, an electronic file to submit via a network or on a physical medium, or other output.

In some embodiments, the processing 202 for matching debtor account records with probate estate records includes applying a scoring algorithm to data of a debtor account record and a probate estate record. The closer certain data items between the records match, the more points that are accumulated. In some embodiments, a match of a date of birth and a Social Security number provides a score higher than a threshold amount that indicates a match.

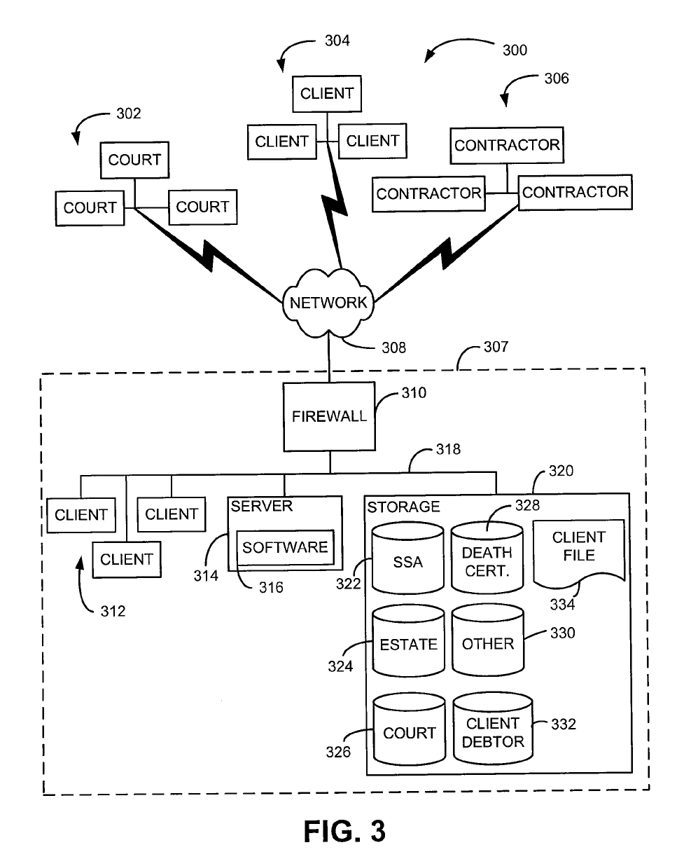

FIG. 3 is a block diagram of portions of a system 300 according to an embodiment. FIG. 3 includes courts 302, clients 304, contractors 306, and a service entity 307 operatively interconnected via a network 308.

The courts 302 are courts in which probate estates of decedents are handled. The clients 304 are clients of the service entity 307 and generally lend money, or otherwise provide credit, to debtors. The service entity 307 is an entity that provides services related to the methods and system described herein to locate and identify probate estates of deceased debtors of client 304. The contractors 306 are optional contract employees or other representatives of the service entity 307 that perform manual probate estate searches and other services for the service entity 307 and provide resulting data to the service entity 307.

The network 308, in some embodiments is the Internet. In other embodiments, the network is a value added network (“VAN”), a proprietary network, virtual private network (“VPN”), a public switched telephone network (“PSTN”), a wired network, a wireless network, a wide area network, a global network, or network of another type capable of providing data connectivity. This data connectivity may be between the courts 302, the clients 304, the contractors 306, the service entity 307, and other entities as needed for a particular embodiment or application of the present subject matter.

The service entity typically includes a firewall 310 that protects a local area network 318. The local area network 318 interconnects client computers 312, a server 314, a storage device 320, and other devices as needed or otherwise selected by the service entity 307.

The storage device 320 represents one or more machines capable of storing data. In some embodiments, the storage device 320 includes one or more machines, such as database and file servers, holding databases and files that are available to other devices and machines on the local area network 318. In some embodiments, the storage device stores client files 334 and databases 322, 324, 326, 328, 330, and 332.

The client files 334 are typically received, or otherwise obtained, from clients 304. In some embodiments, the client files 334 include data of client debtors that are believed to be deceased. In other embodiments the client files 334 also include data of client debtors that a client has not been able to contact or otherwise wants to learn if or when a client debtor dies. The client debtor data also typically includes data of debt accounts.

The debtor identifying data in a client file can vary between clients 304. However, some of the debtor identifying data can include some or all of a client debtor name, address, secondary address, phone number, social security number, spouse data, next of kin data, and other personal and demographic data as may be known and provided by the clients 304.

The databases stored in the storage device 320 can vary between embodiments. However, some embodiments include one or more of the following:
Social Security Administration Database 322—this database includes public data obtained from the Social Security Administration. This data includes social security numbers of decedents and other personal and demographic information that can be useful in determining if an individual has passed.
Death Certificate Database 328—This database includes data obtained from one or more of issuers of death certificates, data obtained from contractors 306 that search death certificate records and provide data over the network 308, and death certificates that are received by the service entity 307. This data can include a decedent names, place of death, and date of death.
Estate Database 324—This database includes data regarding probate estates that have been established for probate or have completed the probate status. Estates in the estate database 324 specify a court having jurisdiction.
Court Database 326—This table includes data identifying courts that have jurisdiction over probate estates in certain geographic areas. In some embodiments, the court database 326 provides a one-to-one relationship between a city, state, zip code combination and a single probate court. Thus, when determining what court in which to search for a probate estate, a decedents city, state, and zip can be used as a key as described above.
Client Debtor Database 332—This database includes data obtained from client files 334 and is updated by further data that is received and processed. In some embodiments, the client debtor database 332 includes data such as a social security number; one or more names including first, middle, and last names; an address specifying a street address, city, state, and zip code; date of death; and a court in which the probate estate exists. The client debtor database 332 also typically includes debtor account data. Each debtor may have one or more accounts.
Other Databases 330—This database reflects that some embodiments may need one or more further databases depending on the requirements for a specific embodiment.

It is to be noted that some of these databases can be combined into a single database, one or more tables within one or more databases, or other data structures depending on service entity 307 needs and resources that are available. Further note, that although the term database is utilized to describe the way in which the data is stored, the term database is intended as a broad term to encompass various data storage methods, including, but not limited to, relational databases, flat files, hierarchical databases, spreadsheets, text files, and other data storage structures, formats, and means.

The server 314 includes software 316 that executes to process data stored in the storage device 320. In some embodiments, the software 316 executes under command of one of the client computers 312. In other embodiments, the software executes on a continual basis to process data received, or otherwise obtained, by the service entity 307 and stored in the storage device 320.

In some embodiments, the software 316 executes on the server 314 to cause the server 314 to process client debtor data from the client debtor database 332 in performance of various tasks. These tasks may include one or more of determining if a client debtor is deceased and identifying a court represented in the court database 326 in which a probate estate exists for the client debtor. The software 316 further executes to cause the server 316 to update the client debtor data in the client debtor database 332 to include the identified court and to generate a claim against the probate estate for multiple accounts of the client debtor on behalf of one of the clients 304. If a probate estate is not identified for a client debtor, the software may place the client debtor in a holding queue for up to a certain period, such as 52 weeks. Client debtors that are in the holding queue are subsequently processed by the software 316 on a recurring basis, such as weekly, until a probate estate is identified or the maximum period of time to be in the holding queue has expired. In other embodiments, client debtors remain in the queue until a match if found or a client otherwise instructs that the client debtor no longer needs to be monitored, such as upon satisfaction of all debt accounts. For example, a client account record in some embodiments may remain in the queue for five years, seven years, or even indefinitely. In such embodiments, the client account record is monitored to ensure timely notice upon a probate estate being created in a court that is relevant to the client account record.

In some embodiments, identifying a court in which a probate estate exists includes comparing data from a client debtor database record to data in estate database records. In some embodiments, identifying a probate estate involves finding a match between one or more fields of an estate database record and a client debtor database record. Such matches, in various embodiments include a social security number match, a combination social security number and name match, or a match between one or more other fields. In some embodiments, a soundex algorithm is used to identify matches between names, or other text fields, to accommodate for misspellings. In some embodiments, a scoring algorithm is used. An example of such a scoring algorithm is assigning values to fields to be matched. The score for a field is accumulated based on identified field matches. If a score sum meets or exceeds a threshold value, a match is found, or assumed.

In some embodiments, when a client debtor is placed in a holding queue, a message is sent by the software 316 to one or more of the contractors 306 over the network 308, or other transmission means, to perform a manual search of an identified court from the court database 326 in which to search for the probate estate. In other embodiments, when a client debtor is placed in the holding queue, a letter to the identified court is generated by the software 316 with a request for any available probate information relating to the client debtor.

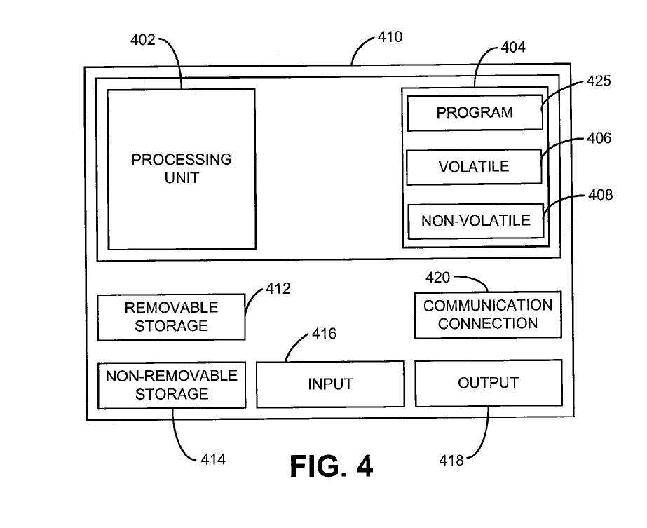

FIG. 4 is a block diagram of a computing device according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 410, may include a processing unit 402, memory 404, removable storage 412, and non-removable storage 414. Memory 404 may include volatile memory 406 and non-volatile memory 408. Computer 410 may include—or have access to a computing environment that includes—a variety of computer-readable media, such as volatile memory 406 and non-volatile memory 408, removable storage 412 and non-removable storage 414. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 410 may include or have access to a computing environment that includes input 416, output 418, and a communication connection 420. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 402 of the computer 410. A hard drive, CD-ROM, and RAM are some examples of articles including a computer-readable medium. An example computer program 425 may be a computer program with instructions executable by the processing unit 402 to perform one or more of the method, or portions thereof, as illustrated and described herein.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the inventive subject matter require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
processing, utilizing a computer processor, debtor account records stored in an account database to match debtor account records with probate estate records stored in a probate estate database;
upon identification of a match of a debtor account record with a probate estate record, associating the debtor account record with the probate estate record;
executing, on the computer processor, a claims process to generate claims against probate estates each represented by a probate estate record, a single claim generated against a probate estate of a debtor for each of a plurality of accounts of the debtor of a particular client, wherein each account is represented by a debtor account record and the debtor and the client are identified in each of the debtor account records.

2. The method of claim 1, wherein associating the debtor account record with the probate estate record includes adding data representative of the debtor account record and data representative of the identified probate estate record to a work in progress (WIP) table.

3. The method of claim 1, wherein associating the debtor account record with the probate estate record includes updating the debtor account record to include an identifier of the probate estate record.

4. The method of claim 1, wherein generating claims includes generating a dataset for each claim including data to populate a court-specific probate estate claim template, the court-specific probate estate claim template stored in a template repository and accessible by a client computing device to present a view of claim datasets and to generate output to use in submitting the claim to a court where the probate estate exists.

5. The method of claim 5, wherein generating output to use in submitting the claim to the court where the probate estate exists includes printing a document.

6. The method of claim 1, wherein matching debtor account records with probate estate records includes applying a scoring algorithm to data of a debtor account record and a probate estate record.

7. The method of claim 1, wherein processing debtor account records stored in an account database to match debtor account records with probate estate records stored in a probate estate database includes:
searching a court identifier database to identify one or more courts in which a probate estate for a debtor of a debtor account record is likely to exist, the searching of the court identifier database performed based at least one item of address data.

8. The method of claim 1, where the claims process, prior to generating a claim against a probate estate identifies a period with regard to time within which claims are to be filed against the probate estate, wherein when the period signifies:
time greater than a configuration setting is remaining to file the claim, generation of the claim is not yet performed allow time for additional debtor account records to be received and matched to the probate estate;
time less than the configuration setting is remaining to file the claim, the claim is generated.

9. A non-transitory computer-readable medium, with instructions stored thereon which when executed by at least one processor of a computing device, causes the computing device to:
process debtor account records stored in an account database to match debtor account records with probate estate records stored in a probate estate database;
upon identification of a match of a debtor account record with a probate estate record, associate the debtor account record with the probate estate record;
execute a claims process to generate claims against probate estates each represented by a probate estate record, a single claim generated against a probate estate of a debtor for each of a plurality of accounts of the debtor of a particular client, wherein each account is represented by a debtor account record and the debtor and the client are identified in each of the debtor account records.

10. The non-transitory computer-readable medium of claim 9, wherein associating the debtor account record with the probate estate record includes adding data representative of the debtor account record and data representative of the identified probate estate record to a work in progress (WIP) table.

11. The non-transitory computer-readable medium of claim 9, wherein associating the debtor account record with the probate estate record includes updating the debtor account record to include an identifier of the probate estate record.

12. The non-transitory computer-readable medium of claim 9, wherein generating claims includes generating a dataset for each claim including data to populate a court-specific probate estate claim template, the court-specific probate estate claim template stored in a template repository and accessible by a client computing device to present a view of claim datasets and to generate output to use in submitting the claim to a court where the probate estate exists.

13. The non-transitory computer-readable medium of claim 12, wherein generating output to use in submitting the claim to the court where the probate estate exists includes printing a document.

14. The non-transitory computer-readable medium of claim 9, wherein matching debtor account records with probate estate records includes applying a scoring algorithm to data of a debtor account record and a probate estate record.

15. The non-transitory computer-readable medium of claim 9, wherein processing debtor account records stored in an account database to match debtor account records with probate estate records stored in a probate estate database includes:
searching a count identifier database to identify one or more courts in which a probate estate for a debtor of a debtor account record is likely to exist, the searching of the court identifier database performed based at least one item of address data.

16. The non-transitory computer-readable medium of claim 9, where the claims process, prior to generating a claim against a probate estate identifies a period with regard to time within which claims are to be filed against the probate estate, wherein when the period signifies:
time greater than a configuration setting is remaining to file the claim, generation of the claim is not yet performed allow time for additional debtor account records to be received and matched to the probate estate;
time less than the configuration setting is remaining to file the claim, the claim is generated.

17. A system comprising:
a processor;
a memory device;
a court database;
a client debtor database; and
software held in the memory device that executes on the processor to cause the system to:
process client debtor data from the client debtor database to determine if a client debtor is deceased;
identify a court represented in the court database in which a probate estate exists for the client debtor;
update the client debtor data in the client debtor database to include the identified court from the court database; and
generate claims against probate estates in the courts in which the probate estates exist, a single claim generated against a probate estate of a client debtor for each of a plurality of accounts of the debtor of a particular client, wherein each account is represented by a record in the client debtor database and the debtor and the client are identified in each of the client debtor database records.

18. The system of claim 17, wherein the generating of a claim against a probate estate first identifies a period with regard to time within which claims are to be filed against the probate estate, wherein when the period signifies:
time greater than a configuration setting is remaining to file the claim, generation of the claim is not yet performed allow time for additional debtor account records to be received and matched to the probate estate;
time less than the configuration setting is remaining to file the claim, the claim is generated.

19. The system of claim 18, wherein the configuration setting is a configuration setting set with regard to each court represented the court database according to a court rule, statute, or other authority setting a period within which claims are to be filed against probate estates.

20. The system of claim 17, wherein client debtor database includes a record for each client debtor, and further wherein each client debtor record includes:
a social security number field;
one or more name fields;
a street address field;
a city field;
a state field;
a zip code field;
a date of death field; and
a court field.
